(19) United States
(12) Patent Application Publication
(10) Pub. No.: US 2021/0365837 A1
(43) Pub. Date: Nov. 25, 2021

(54) SYSTEMS AND METHODS FOR SOCIAL STRUCTURE CONSTRUCTION OF FORUMS USING INTERACTION COHERENCE

(71) Applicants: Kazuaki Kashihara, Tempe, AZ (US); Jana Shakarian, Tempe, AZ (US)

(72) Inventors: Kazuaki Kashihara, Tempe, AZ (US); Jana Shakarian, Tempe, AZ (US)

(73) Assignees: Arizona Board of Regents on Behalf of Arizona State University, Tempe, AZ (US); Cyber Reconnaissance, Inc., Tempe, AZ (US)

(21) Appl. No.: 17/324,303

(22) Filed: May 19, 2021

Related U.S. Application Data
(60) Provisional application No. 63/026,979, filed on May 19, 2020.

(51) Int. Cl. G06N 20/00; G06F 16/31

(52) U.S. Cl. CPC G06N 20/00; G06F 16/31

(57) ABSTRACT

Various embodiments of a system and associated method for determining a social structure in unstructured and/or structured social media forums are disclosed herein.

### CROSS REFERENCE TO RELATED APPLICATIONS

The present application claims benefit to U.S. provisional patent application Ser. No. 63/026,979 filed on May 19, 2020, which is hereby incorporated by reference in its entirety.

### FIELD

The present disclosure generally relates to cybersecurity; and in particular, to a system and associated method for social network analysis of structured or unstructured social media forums.

### BACKGROUND

Extracting social structure from forums and communities is an important task, especially in the cybersecurity field. Researchers have used Social Network Analysis (SNA) to identify key individuals within the hacker's forums and communities in the Deepweb and Darkweb. To build the social network, the member's interaction must be taken into consideration. In the forum, members' activity is followed according to its participation on the forum. In addition, SNA is used for many applications and methods as a part of their features to predict cyber threats and enterprise cyber incidents from Deepweb and DarkWeb forums.

There are several structured forums and communities such as Reddit and Stack Exchange. Reddit is a platform for discussions on a variety of topics on the web. There are many threads under a specific topic, and the responses are shown in tree structure. Stack Exchange is a network of question-and-answer (Q&A) websites on topics in diverse fields, each site covering a specific topic. Each thread has a tree structure to see the replies of the posted question. However, most of the communities and forums in the Deepweb and Darkweb are unstructured, and it is hard to build the social structure from unstructured threads.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a diagram illustrating a creator-oriented network to represent a given unstructured thread interaction in a forum;

FIG. 1B is a diagram illustrating a last-reply-oriented network to represent a given unstructured thread interaction in a forum;

FIG. 1C is a simplified illustration of a system including a plurality of devices for creating a social structure from unstructured data of e.g., an unstructured forum associated with hacker communications;

FIG. 1D is an exemplary method for creating a social structure from unstructured data of e.g., an unstructured forum associated with hacker communications;

FIG. 2 is an illustration showing a sample thread structure and its corresponding user network;

FIG. 3 is graphical representation showing Next Sentence Prediction Accuracy of pre-training with Sentence pairs;

FIG. 4 is a graphical representation showing Next Paragraph Prediction Accuracy of pre-training with balanced Paragraph pairs;

FIG. 5 is a graphical representation showing Next Paragraph Prediction Accuracy of pre-training with unbalanced Paragraph pairs; and

FIG. 6 is a diagram showing an exemplary computing system for use with the present system.

Corresponding reference characters indicate corresponding elements among the view of the drawings. The headings used in the figures do not limit the scope of the claims.

### DETAILED DESCRIPTION

Various embodiments of a system and associated method for mapping or associating posts in a thread with their respective replies to construct a social structure of an internet forum thread are disclosed herein. The present method can build a social structure from posts in an unstructured thread in a social media discussion. The system utilizes a Next Phrase Prediction model which returns “true” when a response post is found to be the direct reply of a post. Experiments were empirically conducted on ten different topics under Reddit's cybersecurity field. The experimental results demonstrate that the present method performs better than traditional approaches. The performance of the present system was compared between BERT's Next Sentence Prediction and the present system's Next Phrase Prediction. If the response is not a single sentence, the present method performs better than previous methods since the replies can be considered thematically related.

### Extracting Social Structure and Network

A Social Network (SN) is a representation of communication networks including a plurality of nodes (i.e. people) and a plurality of edges (arcs). Each edge corresponds to a relationship between nodes. Social Network Analysis (SNA) helps to understand the relationships in a given community through analyzing its graph representation. Users who post in the community are seen as nodes and relations among users are seen as arcs. In this manner, several techniques have been researched such as extract important (key) members, classify users according to his or her relevance within the community, and discovering and describing resulting sub-communities. However, all these approaches leave aside the meaning of relationships among users. Therefore, analysis based only on reply of posts to measure relationship strength is not a good indicator.

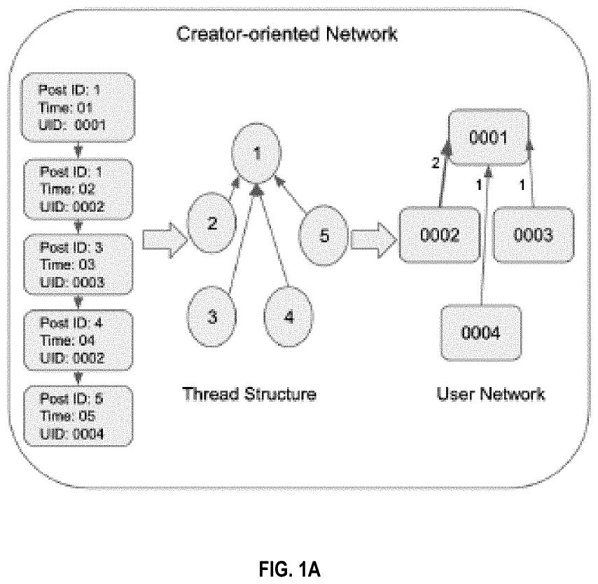

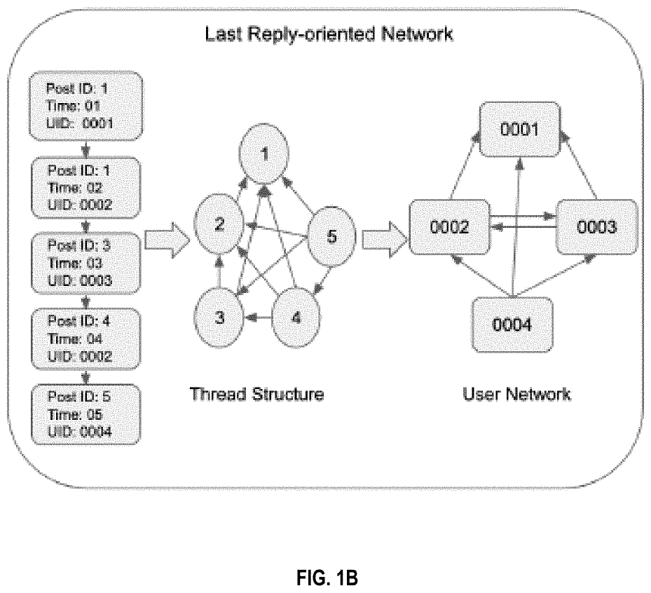

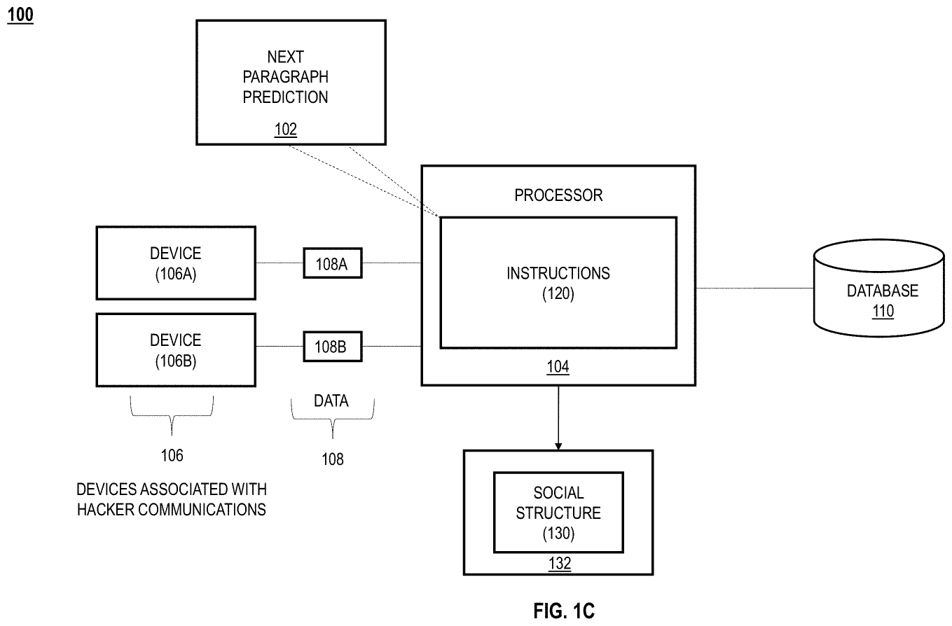

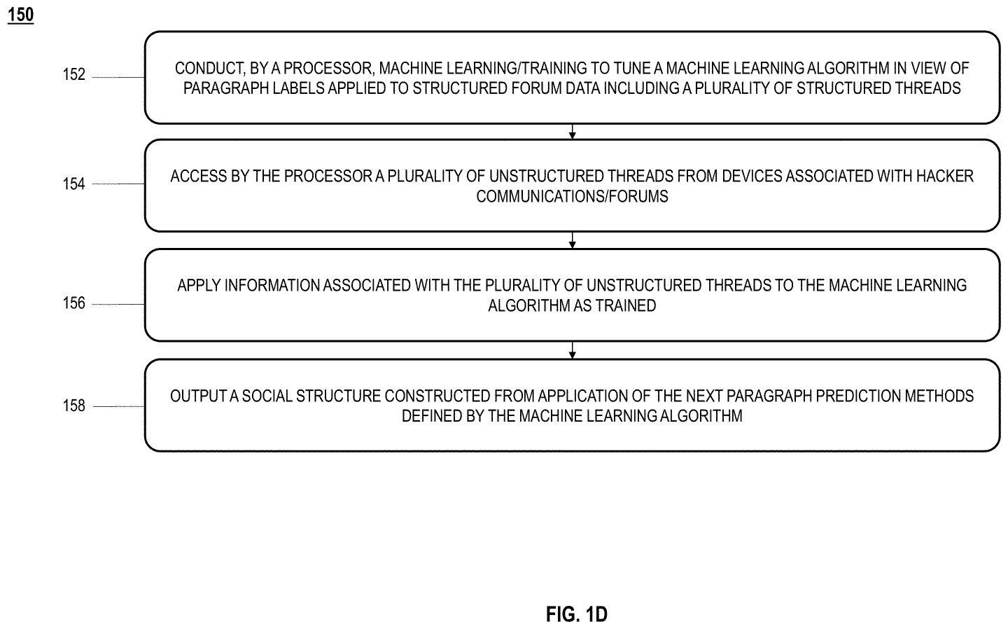

Referring to FIGS. 1A-1B, to build the social network, the members' interaction must be considered. In general, the activities of members are followed according to their participation on the forum such as posting or responding to threads on the forum. There are two network representations introduced:
Creator-oriented Network (FIG. 1A): When a member creates a thread, every reply will be related to him or her. This network representation is the less dense network (density is measured in terms of the number of arcs that the network has).
Last Reply-oriented Network (FIG. 1B): Every reply of a thread is assumed to be a response to the last post. This network representation has a medium density.

In FIGS. 1A and 1B, these two approaches of network conversion of an unstructured thread of a forum are presented. The arcs represent members' replies, and nodes represent the authors of the posts. In the Creator-oriented network approach, the weight of arcs in User Network (social network) are a counter of how many times a given member replies to posts written by another member. The two approaches create very different thread structures and user networks. The Last Reply-oriented Network is widely used for the social network analysis in the recent works.

Since these two traditional network conversion approaches are based on preliminary assumptions, it is suspected that the social structures of the networks are not accurate representations of social structure. Thus, the users' interaction in the thread are considered to reconstruct the thread structures from unstructured threads, then build the social structure based on the thread structures. In addition, BERT (Bidirectional Encoder Representations from Transformer) has Next Sentence Prediction to judge that a sentence is the next sentence of a given sentence. It is assumed that BERT's Next Sentence Prediction can extend to predict the response post from the previous post.

### BERT

BERT (Bidirectional Encoder Representations from Transformer) is a neural network-based technique for Natural Language Processing (NLP) pre-training. BERT helps better understand the nuances and context of words in searches and better match those queries with more relevant results. BERT pre-trains the two tasks: Masked Language Modeling (LM), and Next Sentence Prediction (NSP) with raw corpus. The second task is NSP, where BERT learns to model relationships between sentences. In the training process, the model receives pairs of sentences as input and learns to predict if the second sentence in the pair is the subsequent sentence in the original document.

BERT (Bidirectional Encoder Representations from Transformer) has two steps: pre-training with large raw corpus, and fine-tuning the model for each task. BERT is based on Transformer, which can catch the long distance dependency relations, because it is based on self-attention, and does not use an RNN nor a CNN. The input for BERT is a sentence, pair of sentences, or document, and it represents the sequence of tokens in each case. Each token is the summation of token embedding, segment embedding, and position embedding.

Each word is divided into sub-words, and the non-head part in the subwords will be assigned “##”. For instance, “playing” is divided into “play” and “##ing” as sub-words. If the input is two sentences, segment embedding takes the first sentence token as sentence A embedding, and the second sentence token as sentence B embedding (put “[SEP]” token between two sentences). In addition, the location of each token is learned as position embedding. The head of each sentence is marked with the “[CLS]” token. In the document classification task or two sentences classification task, the final layer of embedding of the token is the representation of the sentence or the two-sentences-set.

BERT pre-trains the following two tasks with the raw corpus: Task 1: Masked Language Modeling (LM), and Task 2: Next Sentence Prediction.

BERT sets Masked LM as a task, it can use Transformer in both directions which read the text input sequentially both left-to-right and right-to-left. For instance, the following sentence is examined:
1. the men went to the store

The randomly selected Word “′went′ from the above sentence is masked and the following sentence is created:
2. the men [MASK] to the store

Then, this sentence is applied Transformer and the model is trained to predict [MASK] part's token correctly.

It is important to capture the relationship between two sentences in the tasks such as Question Answering and Textual Entailment Recognition. Then, Next Sentence Prediction task pre-trains the model. The model receives pairs of sentences as input and learns to predict if the second sentence in the pair is the subsequent sentence in the original document. During training, 50% of the inputs are a pair in which the second sentence is the subsequent sentence in the original document (The following sentence (3)), while in the other 50% a random sentence from the corpus is chosen as the second sentence (The following sentence (4)). The assumption is that the random sentence will be disconnected from the first sentence.
3. [CLS] the man went to the [MASK] [SEP] he bought a gallon of milk [SEP]
4. [CLS] the man [MASK] to the store [SEP] penguin [MASK] are flight ##less birds [SEP]

While only adding a small layer to the core model, BERT can be used for a wide variety of language tasks such as Classification tasks, Question Answering tasks (e.g. SQuAD), and Named Entity Recognition (NER) tasks. For instance, consider sentence pair classification task or sentence classification task. This task is to calculate the probability of each class through P=softmax(CW^{T}) where C is the final layer's embedding corresponding to [CLS] and additional parameter W∈_{R}K×H (K is the number of classes).

### Disclosed System and Method

Referring to FIG. 1C, a computer-implemented system (“system”) 100 is shown for generating and implementing the next paragraph prediction model 102 described herein. As indicated, the system 100 generally includes a processor 104 in communication with a plurality of devices 106, designated by example as device 106A and device 106B. Devices 106 include any computing device or similar hardware device capable of hosting or accessing hacker communication data 108 (including by example dataset 108A and dataset 108B) which includes hacker communications from forums or similar platforms and includes structured or unstructured threads as discussed herein. By non-limiting examples, the devices 106 include any computing device, server, storage device, or similar hardware component that can host, receive, or access information provide such information to the processor 104 in some form. The processor 104 is further in operable communication with one or more of a database 110 stored in some memory or storage device and the data 108 ACE can be organized and stored in the database 110 for retrieval and processing.

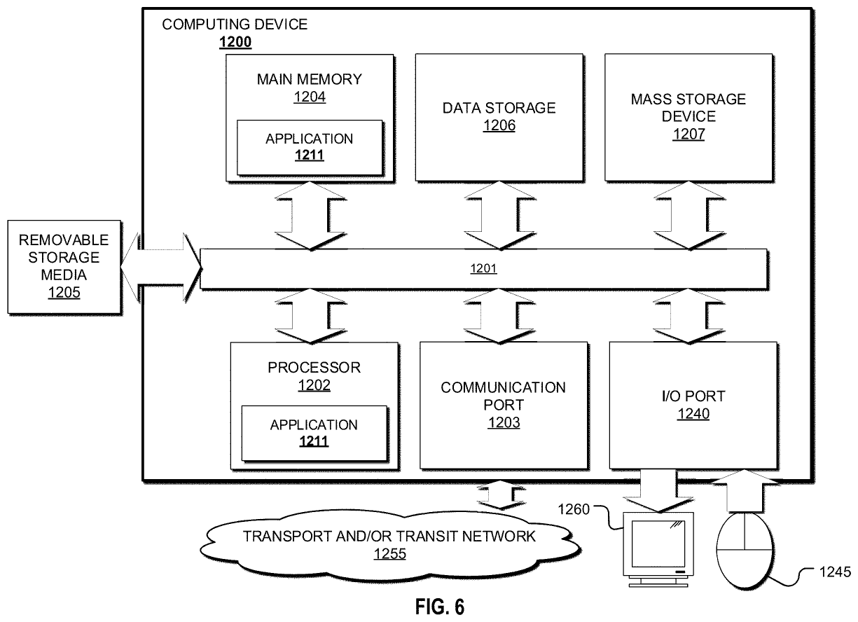

In general, the processor 104 access the data 108 from the devices 106 and the data 108 is organized and stored in the database 110 for training and implementing the next paragraph prediction model 102. As further shown, the processor 104 accesses and executes instructions 120 that configure the processor 104 to execute commands to other devices and otherwise perform operations associated with the next paragraph prediction model 102. The processor 104 may be implemented via one or more computing devices, and may include any number of suitable processing elements. The instructions 120 may further define or be embodied as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, aspects of the next paragraph prediction model 102 functionality described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) of the instructions 120 may be stored in a computer-readable or machine-readable medium (e.g., main memory 1204 of FIG. 6), and the processor 104 performs the tasks defined by the code.

Accordingly, the instructions 120 configure the processor 104 to perform operations for training and implementing the next paragraph prediction model 102, including, e.g., generating a social structure 130 from unstructured threads associated with hacker communications from one or more forums. Aspects of the social structure 130 may be displayed or communicated to a device 132, such as a client device. The system 100 is non-limiting and exemplary, and additional devices are contemplated. FIG. 1D depicts an exemplary method or process 150 for generating and implementing the next paragraph prediction model 102 of FIG. 1C in view of aspects of the system 100.

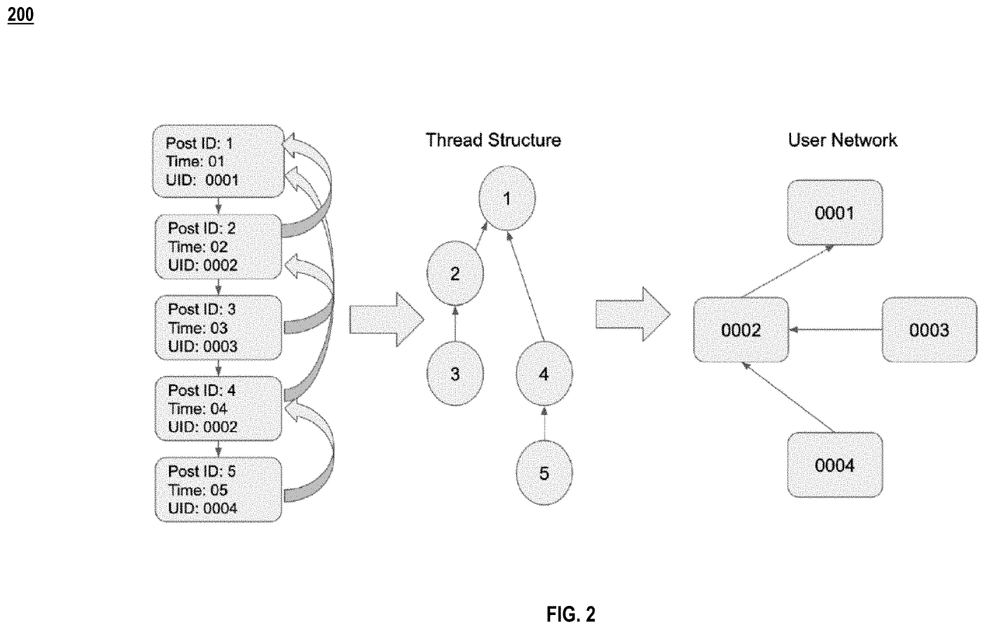

The system and method of FIGS. 1C and 1D address drawbacks of prior methodologies. For example, since both of the traditional networks do not consider the user interaction of the thread correctly if the forum is unstructured, the social networks do not represent the users' interaction accurately. Thus, a new approach to build the thread structures from the unstructured forum to generate more accurate social network is contemplated by the present inventive concept (as shown and referenced herein with respect to FIGS. 1C and 1D). To achieve this goal, it is promising to determine user interaction more clearly through identifying who responds to whose post. For instance, FIG. 2 shows, if the relationship between posts is figured out by understanding the likelihood of each post, the thread structure is constructed even if the thread is unstructured, and the accurate user network is constructed for social network analysis. Each post in the forum's thread is considered to be one paragraph, and extend BERT to predict direct response of the post or reply as next paragraph.

### Next Paragraph Prediction

A Next Paragraph Prediction aspect is introduced that returns true if a response post is a direct response of the previous post in a thread using BERT's Next Sentence Prediction idea. To extend Next Sentence Prediction in BERT to Next Paragraph Prediction, the following differences between sentence and paragraph must be considered.

The next sentence is usually unique. However, the next paragraph (in this case, a responding post to the previous post) may be not unique and multiple responses may exist against a post. Although, in this approach, the replies can be considered thematically related, it could be argued that they are more loosely related (e.g. question and response) than two subsequent sentences. In this regard, the case at hand is semantically closer to two paragraphs.

Next Sentence Prediction creates same number of negative case from the positive case by randomly picking the next sentence from the training corpus. However, this approach may pick another positive paragraph as a negative sample.

Considering the above differences, the training process of Next Paragraph Prediction is shown in Algorithm 1. NextParagraphPredictionTraining algorithm generates the training corpus from the given structured forum data and using the labeled pairs of paragraphs are used for fine-tuning BERT model for Next Paragraph Prediction (block 152 of process 150). The examples of the positive paragraphs pair and negative paragraphs pair are shown in sentences (5) and (6) respectively.
5. [CLS] Just bought a subscription. Thank you for the use ##ful service. We find it very value ##able for aware ##ness [MASK] [SEP] Thank you for the support and kind words [SEP]
6. [CLS] Ok. [MASK]. [SEP] I really [MASK] not know what I am looking honestly. [SEP]

### Social Structure Construction

Referring to blocks 154 and 156 of FIG. 1D, using the fine-tuned model for Next Paragraph Prediction, Social Structure Construction algorithm builds the social structure of unstructured forum to generate the social network of users therein. Algorithm 2 shows the process to generate the social structure of the given unstructured forum. If the Next Paragraph Prediction model (NPPM in Algorithm 2) returns “true” for given two individual posts from same thread, the thread structure puts the edge between the two posts' nodes.

Referring to block 158 of FIG. 1D, once the social structure of unstructured forum is built, the social network (user network) is easily extracted for the social network (user network) from the social structure for Social Network Analysis. This approach will build the accurate social network for unstructured forums compared to the traditional approaches: Creator-oriented Network and Last Reply-oriented Network.

Algorithm 1 NextParagraphPredictionTraining

Input: Structured threads in a forum Forum
Output: Fine-tuned model for Next Paragraph Prediction

| | |
|---|---|
| 1: | TrainTripletList = [ ] |
| 2: | for all Thread ϵ Forum do |

| | |
|---|---|
| 3: | parentDict = { } |
| 4: | postList =list of all posts in Thread |
| 5: | posCount = 0 # count the positive example number per thread |
| 6: | for all post ϵ postList do |

| | |
|---|---|
| 7: | if parentPost of post is not ROOT then |

| | |
|---|---|
| 8: | parentDict[post] = parentPost |
| 9: | TrainTripletList add (True, parentPost, post) |
| 10: | posCount+ = 1 |

| | |
|---|---|
| 11: | end if |

| | |
|---|---|
| 12: | end for |
| 13: | for i = 0; i < posCount; i + + do |

| | |
|---|---|
| 14: | Randomly picks post1 and post2 from postList where post1 ≠ parentDict[post2] |
| | and post1 ≠ post2 |
| 15: | TrainTripletList add (False, post1, post2) |

| | |
|---|---|
| 16: | end for |

| | |
|---|---|
| 17: | end for |
| 18: | Fine-tuning the BERT model with TrainTripletList for training the model for Next Para- |
| | graph Prediction |

Algorithm 2 SocialStructureConstruction

Input: Unstructured threads in a forum Forum, NextParagraphPrediction model NPPM
Output: SocialStructure

| | |
|---|---|
| 1: | ForumStructure |
| 2: | for all Thread ϵ Forum do |

| | |
|---|---|
| 3: | ThreadStructure |
| 4: | postList =list of all posts in Thread |
| 5: | for 1 ≤ i ≤ \|postList\| do |

| | |
|---|---|
| 6: | for 1 ≤ j ≤ \|postList\| do |

| | |
|---|---|
| 7: | if i ≠ j and postList[j] posted after postList[i] then |

| | |
|---|---|
| 8: | post1 = postList[i] |
| 9: | post2 = postList[j] |
| 10: | if NPPM (post1, post2) returns True then |

| | |
|---|---|
| 11: | ThreadStructure add the edge from to post2 to post1 |

| | |
|---|---|
| 12: | end if |

| | |
|---|---|
| 13: | end if |

| | |
|---|---|
| 14: | end for |

| | |
|---|---|
| 15: | end for |
| 16: | ThreadStructure is added to ForumStructure |

| | |
|---|---|
| 17: | end for |
| 18: | Generate SocialStructure of the Forum based on ForumStructure |

### Evaluation

The disclosed method was evaluated with ten different Reddit topics related to the cyber-security field, and compared with the traditional approaches: Creator-oriented Network and Last Reply-oriented Network. The evaluation performance is measured to return the accuracy of the prediction of the correct pairs of paragraphs (post and reply) in the structured threads. The training corpus was generated for fine-tuning the Next Paragraph Prediction model and used for the evaluation as well.

### Data

Reddit is a popular platform for discussing a wide-variety of topics on the web. This discussion platform presents each thread in the forum of a tree structure, so that it is clear to see the users' interactions such as who replies to whose post and when the response is posted. The following ten topics were chosen from “cybersecurity” field in Reddit and the threads of these topics were extracted: “cyber security”, “AskNetsec”, “ComputerSecurity”, “cyberpunk”, “cybersecurity”, “Hacking”, “Malware”, “Malwarebytes”, and “security”

Each post or response under a forum in a topic is considered a paragraph, and the positive pair of the paragraphs is created if a paragraph's ID appears in the response's children list. To create a balanced training dataset, exactly the same number of negative pairs of the paragraphs was created by randomly picking two unrelated paragraphs without parent-child reference. The statistics of the collected ten Reddit topics and the pair of paragraphs are shown in Table 1

TABLE 1

| Topic Name | TH | Sent | Para(B) | Para(UnB) |
|---|---|---|---|---|
| cyber_security | 8 | 48 | 100 | 298 |
| AskNetsec | 14 | 338 | 662 | 3056 |
| ComputerSecurity | 12 | 110 | 228 | 834 |
| cyberpunk | 11 | 176 | 572 | 2056 |
| cybersecurity | 11 | 158 | 302 | 1058 |
| Hacking | 12 | 370 | 826 | 3012 |
| Hacking_Tutorial | 12 | 110 | 226 | 968 |
| Malware | 9 | 82 | 100 | 590 |
| Malwarebytes | 8 | 72 | 142 | 430 |
| security | 8 | 184 | 328 | 1026 |

Para(B) shows the statistic of balanced paragraph pairs that contain both positive and negative pairs in half and half. Thus, the half number of Para(B) in each topic is the number of positive paragraph pairs. Para(UnB) shows the statistic of unbalanced paragraph pairs that contain both positive and negative pairs. Since the number of balanced paragraph pairs is very small in some topics, all combinations of negative pairs were added to each topic. For an ablation experiment, the pairs of sentences are prepared for Next Sentence Prediction model. The positive pairs of sentences are created based on the following assumption:

If Post B is the direct response to Post A, the first sentence of Post B is the next sentence of the last sentence of Post A.

A positive pair of sentences is the pair of the last sentence of Post A, and the first sentence of Post B if Post B exists. Then, a negative pair of sentence is the pair of randomly selected sentences from Post A and Post B excluding the combination of sentences that creates positive pair. If both Post A and Post B have just one sentence, positive and negative pairs are not created from this combination. Sent shows the statistic of Sentence pairs that contain positive and negative pairs half and half. Since there are lots of single word or single sentence posts, the number of Sentence pairs is smaller than the pairs of paragraphs.

### Results

The ablation experiment was performed over the difference between Next Sentence Prediction and Next Paragraph Prediction in order to better understand the relative importance. The performances of Next Sentence Prediction (Sent), Next Paragraph Prediction with balanced data (Para(B)), and Next Paragraph Prediction with unbalanced data (Para(UnB)) are shown in Table 2. The result shows that Next Sentence Prediction approach performs on average 58.6% accuracy, Next Paragraph Prediction with balanced data performs on average 55.2% accuracy, and Next Paragraph Prediction with unbalanced data performs on average 86.2% accuracy respectively. Since the size of training pairs in unbalanced data is the biggest, it is assumed that this training size difference effects the better accuracy.

| | | | | Network Structure | |
|---|---|---|---|---|---|
| | Our Approach | | | Creator- | Last Reply- |
| Topic | Sent | Para(B) | Para(UnB) | oriented | oriented |
| cyber_security | 60.4 | 48.0 | 83.9 | 9.8 | 33.3 |
| AskNetsec | 62.1 | 55.0 | 90.2 | 1.8 | 12.7 |
| ComputerSecurity | 55.5 | 54.8 | 86.3 | 0.9 | 37.4 |
| cyberpunk | 59.7 | 63.5 | 86.0 | 1.7 | 7.7 |
| cybersecurity | 62.0 | 52.6 | 86.2 | 7.2 | 13.8 |
| Hacking | 61.6 | 63.1 | 87.6 | 2.2 | 5.8 |
| Hacking_Tutorial | 61.8 | 56.8 | 86.8 | 6.7 | 13.4 |
| Malware | 51.2 | 45.0 | 84.2 | 5.5 | 24.2 |
| Malwarebytes | 51.4 | 56.3 | 86,6 | 11.1 | 30.6 |
| security | 59.8 | 57.0 | 83.7 | 13.3 | 15.8 |

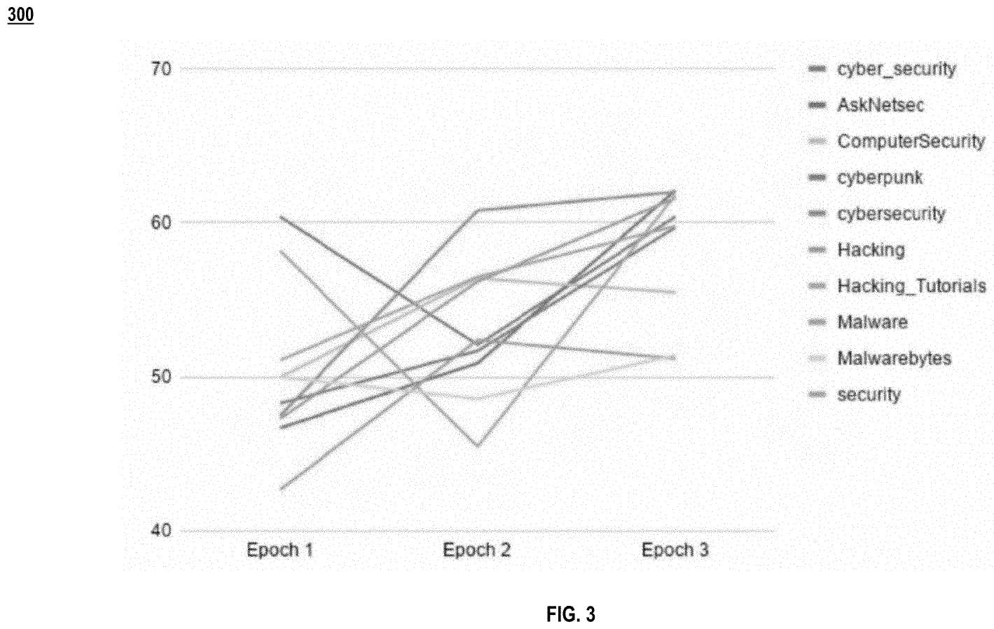

Next Sentence Prediction approach performs better when many of the posts have single sentence or just few words in a topic. However, the size of training data for Next Sentence Prediction approach was smaller than Next Paragraph Prediction approaches with both balanced and unbalanced training data. FIG. 3 shows the performance of Next Sentence Prediction approach in each epoch. Some of the topics dropped the accuracy in the second or third epoch. A Next Sentence Prediction training data issue was found; the issue being that random sentence selection causes the system to pick very similar sentences of positive pairs. For instance, a positive pair (“Reddit”, “Thank you!”) and a negative pair (“Trojan4”, “thank you for your help”). Both of them are very similar responses, and only one of them is positive. Next Sentence Prediction is more challenging to consider the semantic meaning if it just considers a sentence of the multiple sentences' post.

Next Paragraph Prediction approach performed better when more training data is provided even if it is unbalanced. In “cyberpunk”, “Hacking”, and “Malwarebytes” cases. Next Paragraph Prediction approach with balanced data performs better than Next Sentence Prediction approach. Many of the posts in these topics have multiple questions or answers. Thus, it is believed that Next Paragraph Predict approach can consider more semantic meaning of each post than Next Sentence Predict approach.

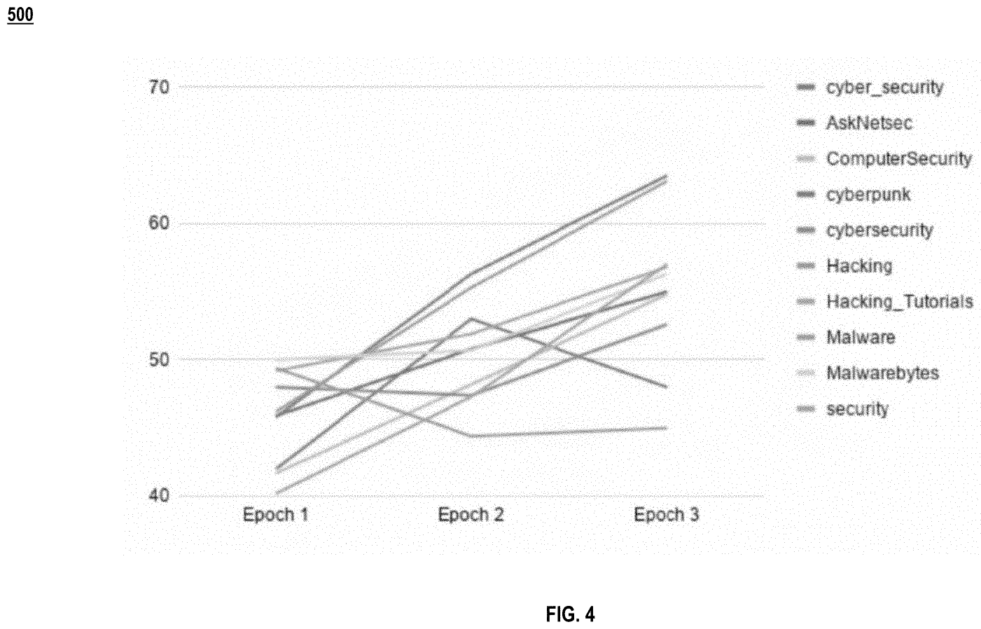

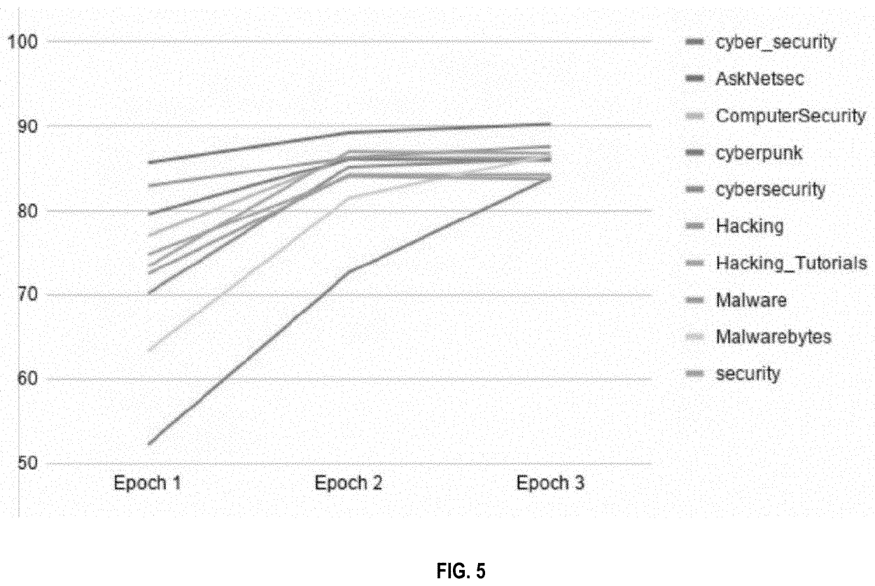

The accuracy of the Next Paragraph Prediction method was compared with the traditional approaches: Creator-oriented Network structure and Last Reply-oriented Network structure. The fine-tuning runs three epoch as following the original BERT paper. The result is shown in Table 2. The present approach shows better performance than the traditional approaches, especially increasing the accuracy every epoch in most of the cases (in FIG. 4 and FIG. 5). This result shows that the Next Paragraph Prediction approach predicts the response(s) of the posts in the unstructured threads well, especially when as many training pairs are provided.

It was a surprising result that the traditional approaches' performances were not as high as expected. The highest accuracy of Creator-oriented approach is 13.3% in “security” topic, and the highest accuracy of Last Reply-oriented approach is 37.4% in “ComputerSecurity” topic. Both network structures are constructed based on the assumption that every reply post will be related to the original post, and every reply of a thread will be a response to the last post. This result shows that these assumptions do not represent the thread structure accurately.

Next Sentence Prediction in BERT was extended to Next Paragraph Prediction for predicting the response posts of a post in the unstructured thread. The initial evaluation shows the present Next Paragraph Prediction approach achieves on average over 80% accuracy in ten individual topic forums under cybersecurity field after third epoch to fine-tuning the model. This result means that the Next Paragraph Prediction model receives two posts (paragraphs) in an unstructured thread as input, and predicts if the second post in the pair is the response post in the thread in high accuracy. In addition, the result of the ablation experiment compared with Next Sentence Prediction approach was also disclosed. The Next Prediction approach shows that Next Paragraph Prediction can consider semantic meanings in the posts if the posts have multiple sentences, and increases the performance. Thus, the present system can construct very accurate thread structure from unstructured thread, then build the social network from the thread structure.

### Computing Device

FIG. 6 illustrates an example of a suitable a computing device 1200 which may be configured, via one or more of an application 1211 or computer-executable instructions, to execute functionality of the present inventive concept. More particularly, in some embodiments, aspects of the system 100 and/or the instructions 120 described herein may be translated to software or machine-level code, which may be installed to and/or executed by the computing device 1200 such that the computing device 1200 is configured to generate a social structure from an unstructured forum, as described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without depart from the spirit and scope of the invention as will be apparent to those skilled in the art. Such changes and modifications are within the scope and teachings of this invention as defined in the claims appended hereto.

What is claimed is:

1. A system, comprising:
a data repository including a set of forum data, the set of forum data associated with a forum, wherein the forum includes a plurality of unstructured threads, each of the plurality of unstructured threads comprising a plurality of posts; and
a processor in communication with the data repository, the processor including instructions that, when executed, cause the processor to:
access the forum data including the plurality of threads and each of the plurality of posts of each of the plurality of threads,
generate a thread structure for each of the plurality of unstructured threads, wherein the processor:
processes a first post of the plurality of posts and a second post of the plurality of posts using a next paragraph prediction model, wherein the next paragraph prediction model returns a Boolean “true” value if the second post is a reply to the first post; and
adds an edge to the threads structure if the next paragraph prediction model returns a Boolean “true” value, wherein no edge is added if the next paragraph prediction model returns a Boolean “false” value,
wherein the thread structure includes the plurality of posts and a plurality of edges, wherein each of the plurality of edges is representative of a relationship between the first post and the second post,
generate a forum structure of the forum based on the thread structure of each of the plurality of unstructured threads, and
generate a social structure of the forum based on the forum structure.

2. The system of claim 1, wherein processing a first post of the plurality of posts and a second post of the plurality of posts using a next paragraph prediction model is repeated iteratively until each post in the thread is processed.

3. The system of claim 1, further comprising training the next paragraph prediction model using a next paragraph prediction training model.

4. The system of claim 3, wherein the next paragraph prediction training model generates a training corpus from given structured forum data.

5. The system of claim 1, wherein the processor generates the thread structure using a neural network.

6. The system of claim 5, wherein the neural network is trained using a Bidirectional Encoder Representations from Transformer (BERT) technique.

7. A method for constructing social structure from unstructured data using interaction coherence, comprising:
training a machine learning model, by:
accessing, by a processor, structured threads associated with hacker communications, and
generating a training corpus from the structured threads, the training corpus labeling pairs of paragraphs to tune the machine learning model;
applying the machine learning model to generate a social structure for a plurality of unstructured threads by:
processing a first post of the plurality of posts and a second post of the plurality of posts using a next paragraph prediction model, wherein the next paragraph prediction model returns a Boolean “true” value if the second post is a reply to the first post, and
adding an edge to the threads structure if the next paragraph prediction model returns a Boolean “true” value, wherein no edge is added if the next paragraph prediction model returns a Boolean “false” value;
wherein the social structure includes the plurality of posts and a plurality of edges, wherein each of the plurality of edges is representative of a relationship between the first post and the second post.

8. The method of claim 7, further comprising training the machine learning model by:
for all of the structured threads, identifying a list of posts in each of the structured threads to generate a post list.

9. The method of claim 7, wherein the machine learning model is a BERT (Bidirectional Encoder Representations from Transformer) model.

10. The method of claim 7, further comprising labeling the pairs of paragraphs as positive pairs or negative pairs.

11. A tangible, non-transitory, computer-readable media having instructions encoded thereon, such that a processor, executing the instructions, is configured to:
apply a machine learning model trained to generate a social structure for a plurality of unstructured threads by:
processing a first post of the plurality of posts and a second post of the plurality of posts using a next paragraph prediction model, wherein the next paragraph prediction model returns a Boolean “true” value if the second post is a reply to the first post, and
adding an edge to the threads structure if the next paragraph prediction model returns a Boolean “true” value, wherein no edge is added if the next paragraph prediction model returns a Boolean “false” value;
wherein the social structure includes the plurality of posts and a plurality of edges, wherein each of the plurality of edges is representative of a relationship between the first post and the second post.
